(19) United States
(12) Patent Application Publication
(10) Pub. No.: US 2023/0051273 A1
(43) Pub. Date: Feb. 16, 2023

(54) PHOTOFINISHING SYSTEM FOR LAMINATING FILM LAYER ON PRINT MEDIA TO INCREASE GLOSSINESS

(71) Applicant: HEWLETT-PACKARD DEVELOPMENT COMPANY, L.P., Spring, TX (US)

(72) Inventors: Heungsup PARK, Seongnam-si, Gyeonggi-do (KR); Juntae KIM, Seongnam-si, Gyeonggi-do (KR); Haeseog JO, Seongnam-si, Gyeonggi-do (KR)

(21) Appl. No.: 17/789,562

(22) PCT Filed: Dec. 29, 2020
(86) PCT No.: PCT/US2020/067302

§ 371 Date: Jun. 28, 2022

(30) Foreign Application Priority Data
Jan. 6, 2020 (KR) 10-2020-0001386

(51) Int. Cl. G03G 15/00

(52) U.S. Cl. CPC G03G 15/6585

(57) ABSTRACT

An image forming apparatus includes an image forming part to form an image on a medium and a photo-finishing part to thermally transfer a coating film covering the image onto the medium.

### BACKGROUND

An image forming apparatus prints an image on a print medium by using various printing methods, such as an electrophotographic method and an inkjet method. For example, an electrophotographic image forming apparatus forms an electrostatic latent image by optically scanning a photoconductor charged to a uniform potential and forms a toner image on the photoconductor by supplying toner to the electrostatic latent image. The toner image is transferred to a print medium directly or via an intermediate transfer belt. The toner image transferred to the print medium is attached to the print medium by electrostatic force. A fixer applies heat and pressure to the toner image, thereby fixing the toner image as a permanent image on the print medium. An inkjet image forming apparatus prints an image by ejecting ink onto a print medium.

By using high gloss paper as the print medium, a photograph-like printed image may be obtained. However, glossiness of an image printed on inexpensive plain paper is low, and thus, it is difficult to obtain a photograph-like printed image using the inexpensive plain paper.

### BRIEF DESCRIPTION OF DRAWINGS

FIG. 1 is a schematic view of an image forming apparatus according to an example.

FIG. 2 is a cross-sectional view of one example of a base member.

FIG. 3 is a graph showing results of measuring changes in glossiness before and after a photo-finishing process of an example according to the image density.

FIG. 4 is a graph showing a result of measuring image quality after a photo-finishing process of an example.

FIG. 5 is a graph showing results of perceptual inspection of image quality after a photo-finishing process of an example.

FIG. 6 is a schematic view of an image forming apparatus according to an example.

FIG. 7 is a schematic view of an image forming apparatus according to an example.

### DETAILED DESCRIPTION

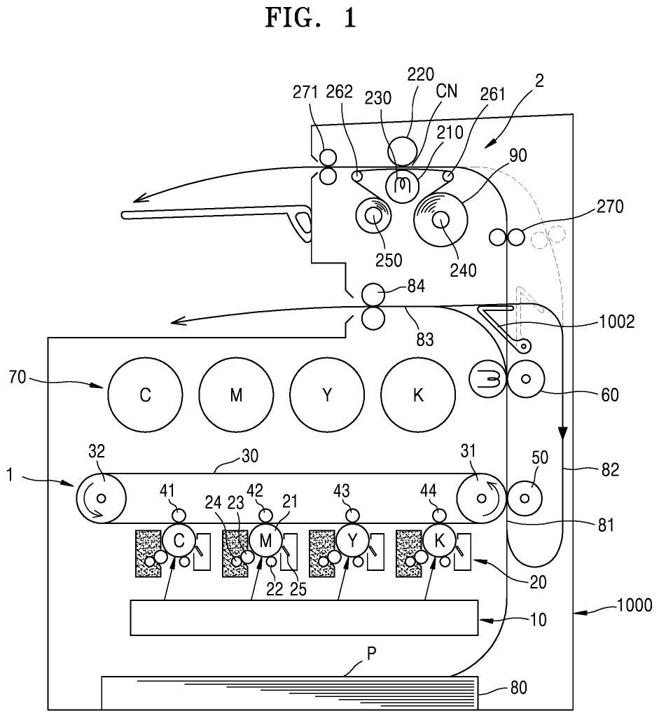

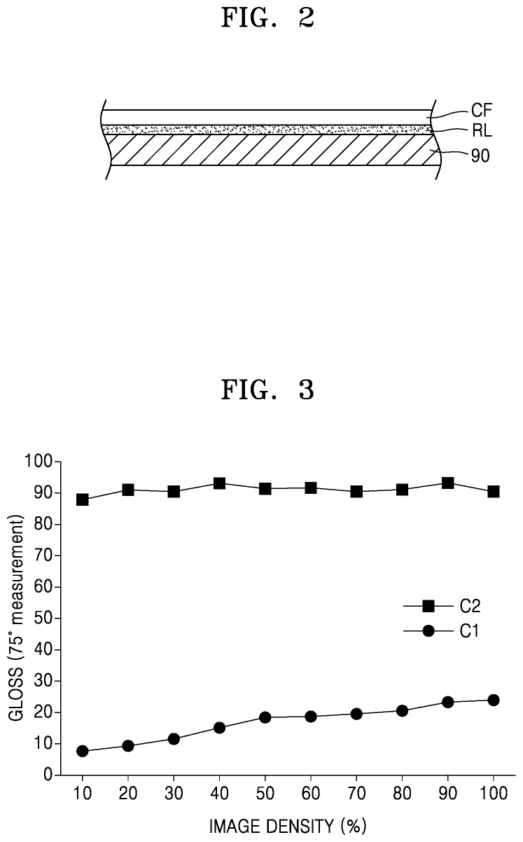

FIG. 1 is a schematic view of an image forming apparatus according to an example. FIG. 2 is a cross-sectional view of one example of a base member 90.

Referring to FIGS. 1 and 2, the image forming apparatus includes an image forming part (which may also be referred to as imager) 1 for forming an image on a print medium P and a photo-finishing part (which may also be referred to as photo-finisher) 2 for thermal-transferring a coating film CF covering an image onto a print medium P. Print medium P may include any medium on which an image may be formed.

The image forming part 1 may print an image on the print medium P by using various printing methods, such as an electrophotographic method and an inkjet method. The image forming part 1 of this example forms a color image on the print medium P by using an electrophotographic method. The image forming part 1 may include an exposing unit 10, a developing device 20, a transfer unit (discussed below), and a fixer 60. For color printing, the developing device 20 may include, for example, four developing devices 20C, 20M, 20Y, and 20K for respectively developing a cyan (C) image, a magenta (M) image, a yellow (Y) image, and a black (K) image.

The four developing devices 20C, 20M, 20Y, and 20K may respectively include a cyan (C) developer, a magenta (M) developer, a yellow (Y) developer, and a black (K) developer, wherein developers may be toners, for example. A cyan (C) toner, a magenta (M) toner, a yellow (Y) toner, and a black (K) toner are respectively included in four toner supply containers 70C, 70M, 70Y, and 70K, and the cyan (C) toner, the magenta (M) toner, the yellow (Y) toner, and the black (K) toner may be supplied to the four developing devices 20C, 20M, 20Y, and 20K from the four toner supply containers 70C, 70M, 70Y, and 70K, respectively. The image forming apparatus may further include developing devices for accommodating and developing toners of various colors, such as light magenta and white, in addition to the above-stated colors. A toner supply container 70 may be replaced when a toner included therein is used up. The developing device 20 may be attached to or detached from the image forming apparatus.

Hereinafter, descriptions of an image forming part 1 including the four developing devices 20C, 20M, 20Y, and 20K will be given, and, unless stated otherwise, reference numerals with C, M, Y, and K refer to components for developing a cyan image, a magenta image, a yellow image, and a black image, respectively.

The developing device 20 may include a photosensitive drum 21. The photosensitive drum 21 may be independent of the developing device 20. The photosensitive drum 21 may be an example of a photosensitive member that an electrostatic latent image is formed on a surface thereof and may include a conductive metal pipe and a photosensitive layer formed on the outer circumference thereof. A charging roller 22 is an example of a charger for charging the photosensitive drum 21 to have a uniform surface electric potential. A charging bias voltage is applied to the charging roller 22. Instead of the charging roller 22, a charging brush or a corona charger may be employed. The developing device 20 may further include a cleaning roller (not shown) for removing foreign substances from the surface of the charging roller 22. A cleaning blade 25 is an example of a cleaning member for removing toner and foreign substances remaining on the surface of the photosensitive drum 21 after a transfer process described below. Instead of the cleaning blade 25, other types of cleaning members, such as a rotating brush, may be employed.

The developing device 20 supplies a toner to an electrostatic latent image formed on the photosensitive drum 21 and develops the electrostatic latent image into a visible toner image. There are a one-component developing method using a toner, and a two-component developing method using a toner and a carrier. The developing device 20 of this example employs the one-component development method. A developing roller 23 supplies a toner in the developing device 20 to the photosensitive drum 21. A developing bias voltage for supplying a toner to the photosensitive drum 21 may be applied to the developing roller 23. This example employs a contact development method in which the developing roller 23 and the photosensitive drum 21 contact each other to form a developing nip. A supply roller 24 supplies the toner in the developing device 20 to the surface of the developing roller 23. To this end, a supply bias voltage may be applied to the supply roller 24. The developing device 20 may further include a regulating member (not shown) to regulate an amount of toner that is attached to the surface of the developing roller 23 and supplied to the developing nip at which the photosensitive drum 21 and the developing roller 23 contact each other. The regulating member may be, for example, a doctor blade that is in elastic contact with the surface of the developing roller 23.

The exposing unit 10 irradiates the photosensitive drum 21 with light modulated in correspondence with image information, thereby forming an electrostatic latent image on the photosensitive drum 21. As the exposing unit 10, a laser scanning unit (LSU) using a laser diode as a light source, an light emitting diode (LED) exposing unit using an LED as a light source, or the like may be employed.

The transfer unit may include an intermediate transfer belt 30, intermediate transfer rollers 41, 42, 43, and 44, and a transfer roller 50. A toner image developed on the photosensitive drum 21 of each of the developing devices 20C, 20M, 20Y, and 20K is temporarily transferred to the intermediate transfer belt 30. The intermediate transfer belt 30 is circularly driven by being supported by supporting rollers 31 and 32. Four intermediate transfer rollers 41, 42, 43, and 44 are arranged at positions facing the photosensitive drums 21 of the developing devices 20C, 20M, 20Y, and 20K across the intermediate transfer belt 30. Intermediate transfer bias voltages for intermediately transferring the toner images developed on the photosensitive drums 21 to the intermediate transfer belt 30 are applied to the four intermediate transfer rollers 41, 42, 43, and 44. Instead of the intermediate transfer rollers 41, 42, 43, and 44, a corona transfer unit or a pin scorotron transfer unit may be employed, for example. The transfer roller 50 is located to face the intermediate transfer belt 30. A transfer bias voltage is applied to the transfer roller 50 to transfer to the print medium P the toner images intermediately transferred to the intermediate transfer belt 30.

When a print command is received from a host or the like (not shown), a control unit (not shown) charges the surface of the photosensitive drum 21 to a uniform electric potential by using the charging roller 22. The exposing unit 10 scans four light beams modulated corresponding to image information of respective colors to the photosensitive drums 21 of the developing devices 20C, 20M, 20Y, and 20K and forms electrostatic latent images on the photosensitive drums 21, respectively. The developing rollers 23 of the developing devices 20C, 20M, 20Y, and 20K supply toners of C, M, Y, and K colors to the corresponding photosensitive drums 21, respectively, thereby developing the electrostatic latent images into visible toner images. The toner images are transferred and overlapped onto the intermediate transfer belt 30. The print medium P loaded on a feed tray 80 is transported along a print path 81 to a transfer nip at which the transfer roller 50 and the intermediate transfer belt 30 face each other. Although not shown, one or more transporting rollers for transporting the print medium P may be arranged in the print path 81. The toner images intermediately transferred onto the intermediate transfer belt 30 are transferred onto the print medium P by a transfer bias voltage applied to the transfer roller 50.

The fixer 60 applies heat and pressure to the print medium P onto which the toner images are transferred, thereby fixing the toner images to the print medium P.

The fixer 60 may be implemented in various forms. For example, the fixer 60 may include a heating member and a pressing member. The heating member and the pressing member elastically press each other to form a fixing nip. The heating member may be implemented, for example, in the form of a heating roller or a fixing belt. The heating member is heated by a heat source. As the heat source, for example, a halogen lamp may be employed. The heating member contacts an image surface of the print medium P, The image surface of the print medium P is the surface of the print medium P onto which the toner images are transferred. When the print medium P, onto which the toner images are transferred, passes through the fixing nip, the toner images are fixed to the print medium P by heat and pressure. The print medium P, to which printing is completed, is discharged out of a main body 1000 by a discharge roller 84 through a discharge path 83.

For duplex printing, the image forming apparatus may include a duplex print path 82 that reverses the print medium P having an image printed on one surface thereof and guides the print medium P back to the print path 81. The duplex print path 82 extends from the discharge path 83 to the print path 81. The duplex print path 82 extends from the discharge path 83 and is connected to an inlet of the transfer nip. Although not shown, the double-side print path 82 may be provided with one or more transporting rollers for transporting the print medium P.

In the case of performing duplex printing, before the rear end of the print medium P, which has one surface having printed thereon an image and is being transported in a forward direction, leaves the discharge roller 84, the discharge roller 84 reversely rotates. As a result, the print medium P is transported in a backward direction along the double-side print path 82 and is fed back to the print path 81, During the process, the other surface of the print medium P (the surface opposite to the surface on which the image is printed) faces the intermediate transfer belt 30. The print medium P that a toner image is transferred to the other surface thereof passes through the fixer 60 and then is discharged out of the main body 1000 through the discharge path 83 by the discharge roller 84.

When high gloss paper, such as a photo paper, is used as the print medium P, the difference between glossiness of a portion where a printed image is formed and glossiness of a portion where no printed image is formed is small, and a photograph-like printed image may be obtained. Photo paper is more expensive than plain paper. After printing an image using low gloss plain paper as the print medium P, a photo-finishing process may be performed to improve the glossiness of a printed image, thereby obtaining a photograph-like printed image. For example, the surface roughness of the image surface of the print medium P may be reduced to improve glossiness by melting a toner by heating/pressing a printed image again and cooling the printed image. However, due to the difference between glossiness of a portion of the image surface with an image (image portion) and glossiness of a portion of the image surface without an image (non-image portion), when a photo-finishing process is performed by heating and cooling, glossiness of the printed image may vary. Also, glossiness may also vary depending on the density of the printed image. Since a toner is densely transferred to a portion of the printed image having a high image density, the surface of the print medium P therebelow is not exposed. Since a toner is less densely transferred to a portion of the printed image having a lower image density, the surface of the print medium P therebelow may be partially exposed. When a photo-finishing process is performed on a printed image by heating and cooling the printed image, the glossiness of the portion having a low image density is lower than that of the portion having a high image density, and thus the glossiness of the printed image may vary even after the photo-finishing process is performed.

The photo-finishing part 2 of this example thermally transfers the coating film CF onto the image surface of the print medium P that has passed through the image forming part 1, thereby improving glossiness of the entire image surface of the print medium P. According to such a configuration, the overall glossiness of the image portion and the non-image portion is improved and the overall glossiness of the portion having a high image density and the portion having a low image density is also improved, and thus, a photograph-like printed material with uniform glossiness may be obtained.

The photo-finishing process may be selectively performed. The print medium P having an image printed on the image surface thereof by the image forming part 1 may be guided along the discharge path 83 without performing a photo-finishing process and discharged out of the main body 1000 by the discharge roller 84 or may be transported to the photo-finishing part 2 for a photo-finishing process.

In an example, the image forming apparatus may include a path selecting member 1002 that is located at an outlet of the image forming part 1 and selectively guides the print medium P to the discharge path 83 and the photo-finishing part 2. The path selecting member 1002 may be switched by a driving unit, e.g., a solenoid, between a first position (the position indicated by solid lines) for directly discharging the print medium P that passed through the image forming part 1 out of the main body 1000 through the discharge path 83 without performing a photo-finishing process thereon and a second position (the position indicated by dashed lines) for guiding the print medium P that passed through the fixer 60 to the photo-finishing part 2 to pass through a coating nip CN. According to such a configuration, selective photo-finishing process may be performed.

For example, when high gloss paper is used as the print medium P, the path selecting member 1002 may be placed at the first position, thereby directly discharging the print medium P that passed through the image forming part 1 out of the main body 1000 without glossing treatment as the photo-finishing process. Also for example, when a low gloss paper is used as the print medium P, the path selecting member 1002 may be placed at the second position, thereby guiding the print medium P that passed through the image forming part 1 to the photo-finishing part 2.

In another example, the duplex print path 82 may be used for a photo-finishing process. For example, when a photo-finishing process is to be performed on the print medium P which is being transported along the discharge path 83, the discharge roller 84 revolves in a reverse direction before the rear end of the print medium P passes through the discharge roller 84. As a result, the print medium P is transported in the reverse direction and enters the duplex print path 82. When the front end of the print medium P leaves the discharge path 83, the print medium P may be transported in the forward direction again and guided from the double-side print path 82 to the photo-finishing part 2. In this example, the path selecting member 1002 may be omitted.

An example of the photo-finishing part 2 will be described below. The photo-finishing part 2 may be implemented in various forms. As shown in the example of FIG. 2, one surface of the base member 90 supports the coating film CF, and the photo-finishing part 2 thermally transfers the coating film CF from the base member 90 to the image surface of the print medium P by using the base member 90.

The base member 90 may include a material that is not deformed at the operating temperature of the photo-finishing part 2. For example, as the base member 90, a polyethylene film, such as polyethylene terephthalate, a polyester film, etc., may be employed. The coating film CF may be a transparent polymer film, for example. The transparent polymer coating film CF is separated from the base member 90 and adhered to the print medium P at a transition temperature. As the coating film CF, a styrene film, an acrylic film, a styrene-acrylic film, etc. may be employed. The thickness of the coating film CF may be from about 1 μm to 50 μm. The thickness of the coating film CF may be 5 μm or greater to maintain rigidity to withstand wear. A coating film CF having a thickness less than or equal to 15 μm may reduce the possibility of curls developing in the print medium P to which the coating film CF is transferred.

A releasing layer RL may be between the base member 90 and the coating film CF. The releasing layer RL facilitates separation of the coating film CF from the base member 90 during a thermal transfer process. The releasing layer RL may include oil which is not deformed at the operating temperature of the photo-finishing part 2, e.g., silicon oil, fluorine-based oil, hydrocarbon oil, etc. When the coating film CF is naturally separated due to a difference between material properties of the coating film CF and the base member 90, the releasing layer RL may not be included.

Referring to FIG. 1, the photo-finishing part 2 may include a pair of coating members that are engaged with each other to form the coating nip N through which the base member 90 and the print medium P pass while overlapping each other and thermally transfer the coating film CF onto the print medium P by heating the base member 90. In an example, the pair of coating members may include a heating roller 210 and pressing roller 220. In an example, the length of the coating nip CN may be from about 3 mm to about 6 mm.

The heating roller 210 may include a hollow metal core including aluminum (Al) or stainless steel. To improve releasability from the base member 90, a releasing layer may be formed on the outer circumference of the metal core. To form a stable coating nip CN, a heat-resistant elastic layer may be provided between the metal core and the releasing layer. The heating roller 210 faces a surface of the base member 90 opposite to the coating film CF and heats the base member 90. The heating roller 210 is heated by a heat source 230. As the heat source 230, a halogen lamp, a heating resistive coil, an induction heater, a ceramic heater, etc. may be employed. In this example, a halogen lamp is employed as the heat source 230. The halogen lamp may be installed inside the metal core at almost the same position as the rotating axis of the heating roller 210. The image surface of the print medium P faces the coating film CF.

The pressing roller 220 is pressed toward the heating roller 210 and forms the coating nip CN through which the print medium P and the base member 90 pass. The pressing roller 220 may have a structure in which a heat resistant elastic layer and a releasing layer including a heat-resistant resin film or a heat-resistant rubber film are formed on the outer surface of the metal core. The pressing roller 220 faces a surface of the print medium P opposite to the image surface and presses the print medium P to the coating film CF in close contact. Although not shown, the pressing roller 220 may also be heated. In this case, a heat source (not shown) for heating the pressing roller 220 may be further provided.

The temperature of the heating roller 210 may be equal to or higher than the thermal transition temperature of the coating film CF. The temperature of the heating roller 210 may range, for example, from about 50° C. to about 200° C. The temperature of the heating roller 210 may range, for example, from about 80° C. to about 150° C. The heating roller 210 may be heated to an appropriate temperature depending on a photo-finishing process speed and the length of the coating nip CN. In an example, when the photo-finishing process speed ranges from about 30 mm/sec to about 50 mm/sec (from 4 pages per minute (ppm) to 10 ppm) and the length of the coating nip CN is from about 3 mm to about 6 mm, the temperature of the heating roller 210 may range from about 80° C. to about 120° C.

The photo-finishing part 2 may include a supply member 240, which is located on the upstream side of the coating nip CN based on a transporting direction of the print medium P and supplies the base member 90 to the coating nip CN, and a retrieving member 250, which is located on the downstream side of the coating nip CN based on the transporting direction of the print medium P and retrieves the base member 90 that passed through the coating nip CN.

The supply member 240 and the retrieving member 250 may be, for example, in the form of rotating reels. The base member 90 by which the coating film CF is supported is provided in the form that one end of the base member 90 is connected to the supply member 240 and wound around the supply member 240. The other end of the base member 90 extends from the supply member 240, passes through the coating nip CN, and is connected to the retrieving member 250. The supply member 240 is rotated in a direction in which the base member 90 is released, and the retrieving member 250 is rotated in a direction in which the base member 90 is wound. The base member 90 released from the supply member 240 is guided to the coating nip CN by a supply guiding member 261. The base member 90 that passed through the coating nip CN is guided to the retrieving member 250 by a retrieval guiding member 262. The supply guiding member 261 and the retrieval guiding member 262 may be implemented in various forms, e.g., cylindrical posts, rotating rollers, and plates having curved surfaces for smoothly guiding the base member 90. A transporting roller 270 transports the print medium P introduced from the image forming part 1 to the coating nip CN. The supply guiding member 261 and the retrieval guiding member 262 are respectively located on the upstream side and the downstream side of the coating nip CN to maintain the base member 90 flat between them. As a result, the print medium P may be stably overlapped with the base member 90. A discharge roller 271 discharges the print medium P that passed through the coating nip CN out of the photo-finishing part 2.

Based on the above configuration, a photo-finishing process will be described.

The print medium P, on which an image is printed by the image forming part 1, is guided to the photo-finishing part 2 by the path selecting member 1002. The transporting roller 270 guides the print medium P to the coating nip CN. The print medium P is overlapped with the base member 90 maintained flat by the supply guiding member 261 and the retrieval guiding member 262 and enters the coating nip CN. At the coating nip CN, the coating film CF is separated from the base member 90 by heat and pressure and is transferred onto the image surface of the print medium P and adhered thereto. The base member 90 from which the coating film CF is separated is wound around the retrieving member 250. The print medium P that the coating film CF is adhered to the image surface thereof is discharged by the discharge roller 271. Therefore, the photo-finishing process is completed.

FIG. 3 is a graph showing results of measuring changes in glossiness before and after a photo-finishing process of an example according to the image density. In FIG. 3, the horizontal axis represents the image density of a printed image, and the vertical axis represents the glossiness. In FIG. 3, C1 represents glossiness before the photo-finishing process, whereas C2 represents glossiness after the photo-finishing process. The glossiness was measured with a glossiness measuring instrument (Model: GlossMaster/GlossMate 75°) of Quality Image Products. Photo finishing conditions are as follows.
Thickness of Coating Film CF: 10 μm
Photo Finishing Speed: 30 mm/sec (4 ppm to 6 ppm)
Coating Nip CN Temperature: 100° C.
Coating Nip CN Length: 4 mm

As shown by C1 and C2 of FIG. 3, the glossiness of a printed image is increased after the photo-finishing process. As described above, when a low gloss plain paper is used as the print medium P, glossiness may vary depending on the image density of a printed image. When such a printed image is photo-finishing processed by a known heating and cooling method, glossiness of a portion having a lower image density becomes lower than that of a portion having a high image density, and thus, the overall glossiness may vary. According to the photo-finishing part 2 of this example, uniform glossiness may be implemented throughout all image densities by thermally transferring and adhering the coating film CF to the entire image surface of the print medium P. A similar result may be obtained when the photo finishing speed is about 50 mm/sec (from 8 ppm to 10 ppm), a temperature of the coating nip CN is about 100° C., and a length of the coating nip N is about 6 mm.

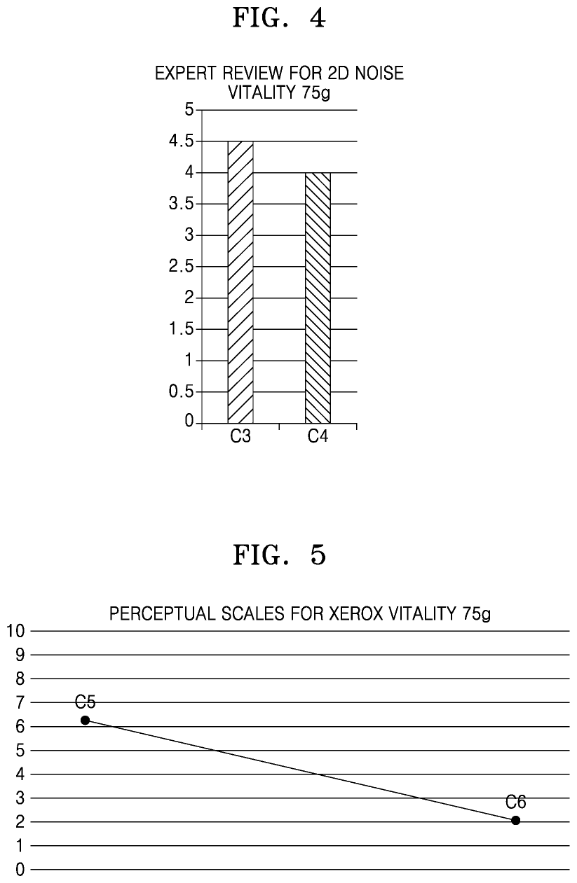

After the photo-finishing process, image defects that affect image quality, such as jitter and bands, are reduced. FIG. 4 is a graph showing a result of measuring image quality after a photo-finishing process according to an example. In FIGS. 4, C3 and C4 represent image quality indices after the photo-finishing process and before the photo-finishing process, respectively. The vertical axis represents image quality indices, which are relative values. A Xerox Validity 75 g paper was used as the print medium P. As shown in FIG. 4, the average image quality index after the photo-finishing process is 4.5, which is an improvement over the average image quality index before the photo-finishing process. The reason therefor may be that a toner on the print medium P is re-melted during the photo finishing process, and thus, image defects, such as jitter and bands, are reduced.

FIG. 5 is a graph showing results of perceptual inspection of image quality after a photo-finishing process according to an example. In FIGS. 5, C5 and C6 represent perceptual scales after the photo-finishing process and before the photo-finishing process, respectively. The vertical axis represents perceptual scales, which are relative values. A Xerox Validity 75 g paper was used as the print medium P. As shown in FIG. 5, the perceptual scale was about 2 before the photo-finishing process and is improved to about 6.2 after the photo-finishing process.

In this regard, by employing the photo-finishing part 2 for coating the coating film CF on the image surface of the print medium P, glossiness of a printed image may be improved and a printed image with high and uniform glossiness may be obtained without being affected by image density. Since the coating film CF is adhered to the image surface of the print medium P, a photograph-like printed material may be inexpensively obtained by using a plain paper as compared to a case of using a photo paper. In the case of a photo-finishing process using the coating film CF, a photograph-like printed material may be obtained at a fraction, for example, as low as one-tenth, of a cost of the case of using a photo paper. Also, since no cooling time is needed, the photo-finishing speed may be improved compared to a photo-finishing process associated with heating and cooling.

Also, since it is not necessary to form a clear toner layer on a non-image portion or both an image portion and a non-image portion to eliminate glossiness unevenness, the structure of an image forming apparatus may be simplified, and thus, the price of the image forming apparatus may be lowered. Also, the photo-finishing part 2 of this example may also be applied to an image forming part for printing an image on the print medium P by using a printing method other than an electrophotographic method, e.g., an inkjet method.

The coating film CF may be divided into a plurality of regions corresponding to the size of the print medium P and may be supported by the base member 90. In this case, the front end of each region and the front end of the print medium P may be aligned and passed through the coating nip CN.

The coating film CF may be supported by the base member 90 in the form of a continuous strip. The coating film CF and the print medium P overlap each other and receive heat and pressure while passing through the coating nip CN. Due to the thickness of the print medium P, the coating film CF may be bent at the front end and the rear end of the print medium P and cut along the front end and the rear end of the print medium P. A structure in which the coating film CF may be easily cut by an angle between a moving path of the print medium P passing through the retrieval guiding member 262 and a moving path of the base member 90 from the retrieval guiding member 262 to the retrieving member 250 may be employed. Of course, the photo-finishing part 2 may include a structure or a device for cutting the coating film CF to the length of the print medium P after the coating film CF and the base member 90 pass through the coating nip CN. Such a structure or device may also be implemented by, as described above, a structure using the angle between the moving path of the print medium P passing through the retrieval guiding member 262 and the moving path of the base member 90 from the retrieval guiding member 262 to the retrieving member 250, and a device for mechanically cutting the coating film CF.

The base member 90 by which the coating film CF is supported, the supply member 240, and the retrieving member 250 may constitute a replaceable cartridge.

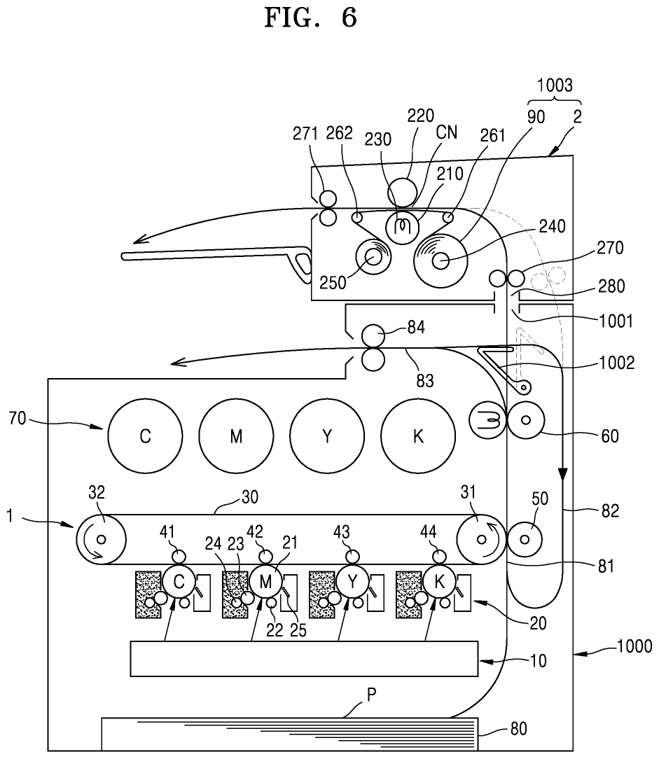

FIG. 6 is a schematic view of an image forming apparatus according to an example. Referring to FIG. 6, the main body 1000 including the image forming part 1 and a post-processing device 1003 are shown. The post-processing device 1003 may include the base member 90, which supports the coating film CF by one surface, and the photo-finishing part 2, which forms the coating nip CN through which the base member 90 and the print medium P overlapped with each other pass and thermally transfers the coating film CF onto the image surface of the print medium P. The post-processing device 1003 may be attached to and detached from the main body 1000.

Hereinafter, an example of the post-processing device 1003 will be described with reference to FIG. 6.

The base member 90 may include a material that is not deformed at the operating temperature of the photo-finishing part 2. For example, as the base member 90, a polyethylene film, such as polyethylene terephthalate, a polyester film, etc., may be employed. The coating film CF may be a transparent polymer film. The transparent polymer coating film CF is separated from the base member 90 and adhered to the print medium P at a transition temperature. As the coating film CF, a styrene film, an acrylic film, a styrene-acrylic film, etc. may be employed. The thickness of the coating film CF may range from about 1 μm to 50 μm. The thickness of the coating film CF may be 5 μm or greater to maintain rigidity withstanding wear. By forming the coating film CF to have a thickness less than or equal to 15 μm, the possibility of curls in the print medium P to which the coating film CF is transferred may be reduced.

A releasing layer RL may be between the base member 90 and the coating film CF, The releasing layer RL facilitates separation of the coating film CF from the base member 90 during a thermal transfer process. The releasing layer RL may include oil which is not deformed at the operating temperature of the photo-finishing part 2, e.g., silicon oil, fluorine-based oil, hydrocarbon oil, etc. When the coating film CF is naturally separated due to a difference between material properties of the coating film CF and the base member 90, the releasing layer RL may not be necessary.

The photo-finishing part 2 may be implemented in various forms. The photo-finishing part 2 may include the supply member 240 having connected thereto one end of the base member 90 and having wound therearound the base member 90, the retrieving member 250 to which the other end of the base member 90 is connected, and a pair of coating members that are located between the supply member 240 and the retrieving member 250, are engaged with each other to form the coating nip CN through which the base member 90 and the print medium P overlapped with each other pass, and thermally transfer the coating film CF onto the print medium P by heating the base member 90. In an example, the pair of coating members may include a heating roller 210 and pressing roller 220. Examples of the supply member 240, the retrieving member 250, the heating roller 210, and the pressing roller 220 may be the same as those described above with reference to FIG. 1, and the descriptions given above for the photo-finishing part 2 of FIG. 1 may be equally applied to the post-processing device 1003. Since the configuration of the main body 1000 shown in FIG. 6 is the same as that of the main body 1000 shown in FIG. 1, descriptions identical to those given above will be omitted.

When the post-processing device 1003 is not mounted on the main body 1000, the print medium P that passed through the image forming part 1 is discharged out of the main body 1000 by the discharge roller 84. When the post-processing device 1003 is mounted on the main body 1000, the print medium P that passed through the image forming part 1 is selectively supplied to the post-processing device 2 and is discharged out of the post-processing device 1003 by a discharge roller 271 after a photo-finishing process. A discharge outlet 1001 connected to the post-processing device 1003 is provided at an upper portion of the main body 1000, and an inlet 280 connected to the discharge outlet 1001 is provided at the post-processing device 1003.

The image forming apparatus may include the path selecting member 1002 for selectively guiding the print medium P that passed through the image forming part 1 to the post-processing device 1003. When the post-processing device 1003 is not mounted, the path selecting member 1002 may be held at a first position (the position indicated by solid lines) for discharging the print medium P that passed through the fixer 60 out of the main body 1000.

When the post-processing device 1003 is mounted, the path selecting member 1002 may be driven by a driving unit, e.g., a solenoid. The path selecting member 1002 may be switched between the first position (the position indicated by solid lines) for directly discharging the print medium P that passed through the fixer 60 out of the main body 1000 without performing a photo-finishing process thereon and a second position (the position indicated by dashed lines) for guiding the print medium P that passed through the fixer 60 to the photo-finishing part 2. According to such a configuration, selective photo-finishing process may be performed. In other words, when a high gloss paper is used as the print medium P, the path selecting member 1002 may be placed at the first position, thereby directly discharging the print medium P that passed through the fixer 60 out of the main body 1000 without glossing treatment. When a low gloss paper is used as the print medium P, as an occasion demands, the path selecting member 1002 may be placed at the second position, thereby guiding the print medium P that passed through the fixer 60 to the post-processing device 1003.

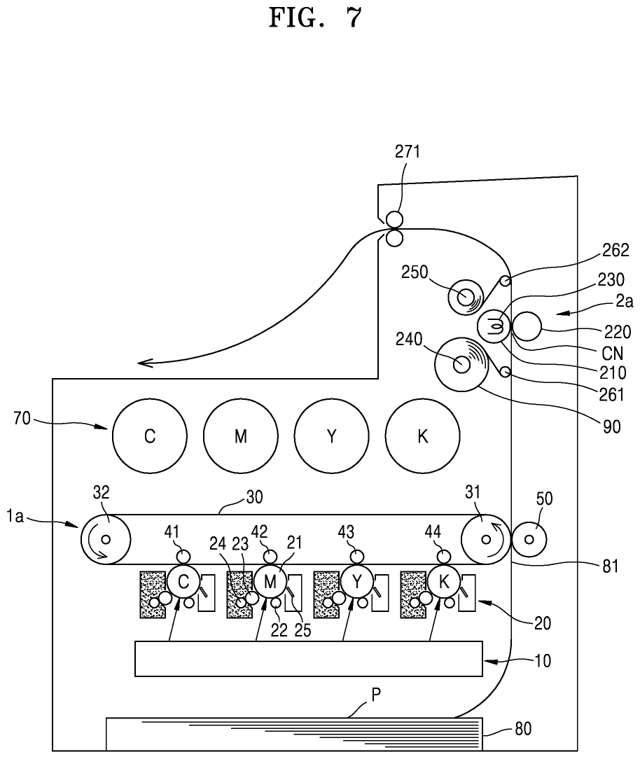

FIG. 7 is a schematic view of an image forming apparatus according to an example. In the image forming apparatus of this example, a photo-finishing part 2a functions as both the fixer 60 and the photo-finishing part 2 shown in FIGS. 1 and 6. From among components shown in FIG. 7, the same components as those shown in FIGS. 1 and 6 are denoted by the same reference numerals, and descriptions thereof will not be repeated.

Referring to FIG. 7, the image forming part 1a and the photo-finishing part 2a are shown. The image forming part 1a of this example forms a toner image on the print medium P by using an electrophotographic method. The photo-finishing part 2a forms the coating nip CN, through which the base member 90 supporting the coating film CF by one surface and the print medium P having formed thereon a toner image pass while being overlapped with each other, and fix the toner image and the coating film CF onto the print medium P.

When a print command is received from a host or the like (not shown), a control unit (not shown) charges the surface of the photosensitive drum 21 to a uniform electric potential by using the charging roller 22. The exposing unit 10 scans, for example, four light beams modulated in correspondence with image information of respective colors to the photosensitive drums 21 of the developing devices 20C, 20M, 20Y, and 20K and forms electrostatic latent images on the photosensitive drums 21, respectively. The developing rollers 23 of the developing devices 20C, 20M, 20Y, and 20K supply toners of C, M, Y, and K colors to the corresponding photosensitive drums 21, respectively, thereby developing the electrostatic latent images to visible toner images. The toner images are transferred onto the intermediate transfer belt 30 while overlapped with each other. The print medium P loaded on a feed tray 80 is transported along a print path 81 to a transfer nip at which the transfer roller 50 and the intermediate transfer belt 30 face each other. The toner images intermediately transferred onto the intermediate transfer belt 30 are transferred onto the print medium P by a transfer bias voltage applied to the transfer roller 50.

The print medium P including the toner images is transported to the photo-finishing part 2. The print medium P is overlapped with the base member 90, which is supplied from the supply member 240 and is maintained flat by the supply guiding member 261 and the retrieval guiding member 262, and enters the coating nip CN. The image surface of the print medium P faces the coating film CF. At the coating nip CN, the toner images are melted and fixed to the print medium P by heat and pressure, and, at the same time, the coating film CF is separated from the base member 90 and is transferred and adhered to the image surface of the print medium P. The base member 90 from which the coating film CF is separated is wound around the retrieving member 250, The print medium P having the coating film CF adhered to the image surface thereof is discharged out of the photo-finishing part 2 by the discharge roller 271. Therefore, fixing the toner images onto the print medium and the photo-finishing process is completed simultaneously.

According to this configuration, compared to the example of the image forming apparatus shown in FIGS. 1 and 6, the fixer 60 may be omitted, and thus an image forming apparatus capable of performing a photo-finishing process at a low cost may be implemented.

It should be understood that examples described herein should be considered in a descriptive sense only and not for purposes of limitation. Descriptions of features or aspects within each example should typically be considered as available for other similar features or aspects in other examples. While one or more examples have been described with reference to the figures, it will be understood by those of ordinary skill in the art that various changes in form and details may be made therein without departing from the spirit and scope as defined by the following claims.

What is claimed is:

1. An image forming apparatus comprising:
an image forming part to form an image on a medium; and
a photo-finishing part to receive the medium from the image forming part and to thermally transfer a coating film onto the medium to cover the image.

2. The image forming apparatus of claim 1, further comprising a path selecting member located at an exit of the image forming part to selectively guide the medium to the photo-finishing part.

3. The image forming apparatus of claim 1, wherein the photo-finishing part is attachable to and detachable from a main body comprising the image forming part.

4. The image forming apparatus of claim 1, wherein the coating film is supported by a base member and the photo-finishing part comprises coating members to engage with one another to form a coating nip through which the base member and the medium pass while overlapping each other and to thermally transfer the coating film onto the medium by heating the base member.

5. The image forming apparatus of claim 4, further comprising a releasing layer between the base member and the coating film.

6. The image forming apparatus of claim 5, wherein the base member includes at least one of a polyethylene film and a polyester film,
the coating film includes at least one of a styrene film, an acrylic film, and a styrene-acrylic film, and
the releasing layer includes at least one of silicon oil, fluorine-based oil, and hydrocarbon oil.

7. The image forming apparatus of claim 4, wherein a thickness of the coating film is less than or equal to about 15 μm.

8. The image forming apparatus of claim 4, wherein the photo-finishing part comprises:
a supply member, on an upstream side of the coating nip with respect to a transporting direction of the medium, to supply the base member supporting the coating film to the coating nip; and
a retrieving member, on a downstream side of the coating nip with respect to the transporting direction of the medium, to retrieve the base member that passed through the coating nip.

9. The image forming apparatus of claim 4, wherein the coating members comprise a heating roller and pressing roller, and
a temperature of the heating roller ranges from about 80° C. to about 150° C.

10. The image forming apparatus of claim 1, wherein the image forming part electrophotographically forms a toner image on the medium, and
the photo-finishing part including a coating nip through which a base member supporting the coating film and the medium pass while overlapping each other, to fix the toner images and the coating film onto the medium.

11. A post-processing device comprising:
a base member including a surface to support a coating film; and
a photo-finishing part to form a coating nip through which the base member and a medium pass while overlapping each other and to thermally transfer the coating film onto an image surface of the medium.

12. The post-processing device of claim 11, wherein the photo-finishing part comprises:
a supply member to connect to one end of the base member and to support the base member;
a retrieving member to connect to another end of the base member; and
coating members, between the supply member and the retrieving member, to form the coating nip through which the base member and the medium pass while overlapping each other, and to thermally transfer the coating film onto the medium by heating the base member.

13. The post-processing device of claim 11, further comprising a releasing layer between the base member and the coating film.

14. The post-processing device of claim 13, wherein a base material includes at least one of a polyethylene film and a polyester film,
the coating film includes at least one of a styrene film, an acrylic film, and a styrene-acrylic film, and
the releasing layer includes at least one of silicon oil, fluorine-based oil, and hydrocarbon oil.

15. The post-processing device of claim 11, wherein a thickness of the coating film is less than or equal to about 15 μm.
